(19) United States
(12) Patent Application Publication
(10) Pub. No.: US 2010/0018768 A1
(43) Pub. Date: Jan. 28, 2010

(54) CABLE WITH CRIMPING TERMINAL AND METHOD OF MAKING THE SAME

(75) Inventors: Ken Takahashi, Mito (JP); Kotaro Tanaka, Nakagun (JP)

Correspondence Address: FOLEY AND LARDNER LLP;SUITE 500, 3000 K STREET NW, WASHINGTON, DC, 20007, US

(73) Assignee: HITACHI CABLE, LTD.

(21) Appl. No.: 12/468,486

(22) Filed: May 19, 2009

(30) Foreign Application Priority Data
Jul. 22, 2008 (JP) 2008-188739

(51) Int. Cl. H01R 4/18; H01R 43/02

(52) U.S. Cl. 174/74 R; 29/860; 439/877

(57) ABSTRACT

A cable with a crimping terminal includes a cable including a conductor and an insulator including a plastic material, and the crimping terminal bonded to the conductor of the cable at a crimping portion by crimping connection. The conductor of the cable is bonded to the crimping terminal by a metallic bonding material at a crimping portion, and the metallic bonding material includes silver as a main component.

The present application is based on Japanese patent application No. 2008-188739 on Jul. 22, 2008, the entire contents of which are incorporated herein by reference.

### BACKGROUND OF THE INVENTION

1. Field of the Invention

This invention relates to a cable with crimping terminal that has a structure that a conductor of a cable and a crimping are connected by crimping connection, and a method of fabricating the same, particularly, relates to the cable with crimping terminal that is used in a high-temperature environment such as in the vicinity of a motor or an inverter of a hybrid car, and in the vicinity of an anchorage device of a copy machine and a method of making the same.

2. Description of the Related Art

A cable with crimping terminal is widely used as a wiring part for feeding electrical power or transmitting signals to various devices.

FIG. 3 is a plan view schematically showing a conventional cable with crimping terminal, FIG. 4 is a perspective view in FIG. 3, and FIG. 5 is a cross-sectional view taken along the line A-A in FIG. 3.

As shown in FIGS. 3 to 5, the conventional cable with crimping terminal 30 has a structure that a conductor 32 of a cable 31 and a crimping 33 are connected by crimping connection. Hereinafter, a portion where the crimping connection is carried out is referred to as “a crimping portion 34”.

The cable 31 is configured to have the conductor 32 and insulator 35. As the conductor 32, twisted wires are generally used, and as a single wire conductor which constitutes the twisted wires, a soft copper wire coated with tin plating is widely used. Tin is used for corrosion prevention, and a wire coated with nickel or silver plating is also used depending on the intended use.

As the insulator 35, a plastic material such as polyethylene, vinyl chloride and fluorine resin can be used depending on the intended use. Particularly, with regard to the cable required to have heat resistance, it is necessary to consider the rated temperature of the insulator, and generally, the rated temperature of the insulator is almost 125 degrees C. at the highest in case of the insulator formed of vinyl chloride as a main material, almost 150 degrees C. at the highest in case of cross-linked polyethylene, and almost 250 degrees C. at the highest in case of fluorine resin.

The crimping terminal 33 includes a base portion, and as the material of the base portion, copper is generally used. Mainly, in terms of the corrosion prevention, the surface of copper is often coated with a metal plating such as tin, nickel or silver plating.

An external connection part 36 of the crimping terminal 33 is fabricated to have various shapes depending on the intended use. FIGS. 3 to 5 show a structure example of the external connection part 36 in which a through-hole 37 is formed for being fixed to a screw hole of an external terminal by using a bolt.

As described above, the conductor 32 of the cable 30 and the crimping terminal 33 are connected at the crimping portion 34. As shown in FIG. 4, generally, the crimping portion 34 is configured to have a structure that the conductor 32 is enclosed with the crimping terminal 33. Both are plastically deformed by application of physical pressure.

In order to increase the breaking strength of the crimping portion 34, it is necessary to carry out the crimping connection by applying an appropriate pressure. Therefore, generally, after preliminarily obtaining knowledge about a relationship between a conductor cross-section ratio of the crimping portion 34 and an applied pressure, and further between a breaking mode and the conductor cross-section ratio, the crimping connection is carried out by applying an appropriate pressure.

Here, the conductor cross-section ratio means a value obtained by expressing in percentage a ratio of the cross-sectional area after the crimping connection of the conductor 32 to the cross-sectional area before the crimping connection of the conductor 32. Further, the breaking strength means a value of load that if the load is applied, a breaking occurs when a tensile test of the crimping portion 34 is carried out, and the breaking mode means a configuration of the breaking portion. The breaking mode is classified roughly into “conductor breaking” and “conductor disengagement”.

In the crimping portion 34, it is targeted that (1) the breaking strength is not less than 80% of the breaking load in case of only the conductor, ideally, not less than 90% and (2) the breaking mode is “conductor disengagement”.

In order to achieve these targets, the conductor cross-section ratio becomes one of important parameters. Although an appropriate conductor cross-section ratio is somewhat different dependent on the size of the conductor 32 and the shape of the crimping terminal 33, in the crimping portion 34 of the conventional cable with crimping terminal 30, the conductor cross-section ratio which is within the range of 70% to 80%, and the breaking strength which is 80% to 90% of the breaking load in case of only the conductor have been obtained.

As another example of the conventional cable with crimping terminal, a cable is disclosed, which has a structure that a solder material (not shown) is sandwiched between the crimping terminal 33 and the conductor 32 of the conventional cable with crimping terminal 30 (for example, with reference to Patent Literature 1).

The solder material is disposed for the purpose of decreasing electrical contact resistance between the crimping terminal 33 and the conductor 32, and the connection strength of the crimping portion 34 is ensured by the above-mentioned plastic deformation of the crimping terminal 33 and the conductor 32.

Patent Literature 1: JP-A-2001-6783

Patent Literature 2: JP-A-H09(1997)-82377

As the bonding material for metals, an alloy brazing material is widely used, but generally, it is difficult to apply the material to the cable with crimping terminal since it has high melting point and causes damage to the insulator formed of a plastic material.

Further, the solder material generally used is mechanically brittle, so that it has been difficult to obtain sufficient breaking strength when the material is applied to the crimping portion of the cable with crimping terminal, although as described above the material is effective for decreasing the contact resistance.

Furthermore, the conventional cable with crimping terminal has a problem that if the cable is used in a high-temperature environment, the breaking strength of the crimping portion is remarkably decreased. And, it has been difficult to obtain the breaking strength just after the crimping connection which is more than 90% of the breaking load in case of only the conductor.

### SUMMARY OF THE INVENTION

Therefore, it is an object of the invention to provide a cable with a crimping terminal that is highly-reliable due to the fact that the breaking strength just after the crimping connection is high, and even if the cable is used in a high-temperature environment, the decrease in the breaking strength is suppressed to an extremely small amount at the crimping portion and to provide a method of making the same.
(1) According to one embodiment of the invention, a cable with a crimping terminal comprises:

a cable comprising a conductor and an insulator comprising a plastic material; and

the crimping terminal bonded to the conductor of the cable at a crimping portion by crimping connection,

wherein the conductor of the cable is bonded to the crimping terminal by a metallic bonding material at a crimping portion, and

the metallic bonding material includes silver as a main component.

In the above embodiment (1), the following modifications and changes can be made.
(i) The metallic bonding material includes a sintered body of the silver fine particles.
(ii) The conductor and the crimping terminal comprise a metallic material including copper as a main component, and the metallic bonding material includes an alloy material including silver and copper.
(iii) The conductor and/or the crimping terminal comprises a tin plating layer on a surface thereof and the metallic bonding material comprises an alloy material containing silver, copper and tin.
(2) According to one embodiment of the invention, a method of making a cable with a crimping terminal comprises:

providing a cable comprising a conductor and an insulator comprising a plastic material, and providing a crimping terminal;

applying a metallic bonding material in a liquid or paste form including silver fine particles of not more than 100 nm in an average particle size to the conductor of the cable and/or the crimping terminal;

bonding the conductor and the crimping terminal at a crimping portion by crimping connection; and

heating the crimping portion at a temperature of not more than a melting point of the insulator so as to fusion-bond the metallic bonding material to the conductor and the crimping terminal.
(3) According to one embodiment of the invention, a method of making a cable with a crimping terminal comprises:

providing a cable comprising a conductor and an insulator comprising a plastic material, and providing a crimping terminal;

applying a metallic bonding material in a liquid or paste form including silver oxide particles to the conductor of the cable and/or the crimping terminal;

bonding the conductor and the crimping terminal at a crimping portion by crimping connection; and

heating the crimping portion at a temperature of not more than a melting point of the insulator so as to fusion-bond the metallic bonding material to the conductor and the crimping terminal.

### ADVANTAGES OF THE INVENTION

According to one embodiment of the invention, a cable with a crimping terminal is capable of increasing the breaking strength just after the crimping connection, and suppressing the decrease in the breaking strength to extremely small amount, even if the cable is used in a high-temperature environment at the crimping portion.

### BRIEF DESCRIPTION OF THE DRAWINGS

The preferred embodiments according to the invention will be explained below referring to the drawings.

FIG. 1 is a cross-sectional view schematically showing a crimping portion of a cable with a crimping terminal in one embodiment according to the invention;

FIG. 2 is a graph schematically showing a relationship between the breaking strength and the conductor cross-section ratio in the crimping portion in each of Examples 1, 2 and Comparative Examples 1, 2;

FIG. 3 is a plan view schematically showing the conventional cable with the crimping terminal and the cable with the crimping terminal according to the invention;

FIG. 4 is a perspective view schematically showing the cable with the crimping terminal shown in FIG. 3; and

FIG. 5 is a cross-sectional view schematically showing the cable with the crimping terminal taken along X-X line in FIG. 3.

### DETAILED DESCRIPTION OF THE PREFERRED EMBODIMENTS

The preferred embodiments according to the invention will be explained below referring to the drawings.

Generally, as the bonding material for metals, an alloy brazing material is widely used, however, since it has high melting point, there has been a problem that it is difficult to use the alloy brazing material as the bonding material of the crimping portion of the cable with crimping terminal which has the insulator formed of a plastic material.

On the other hand, it is known that in case of metallic particles, if the particle size becomes small to the extent of a nano-size, the melting point is decreased so that a fusion bond is caused at a low temperature. The inventors etc. take particular note of the fusion bond phenomenon at a low temperature of the metallic particle, and utilize silver fine particles as a bonding material of the crimping portion.

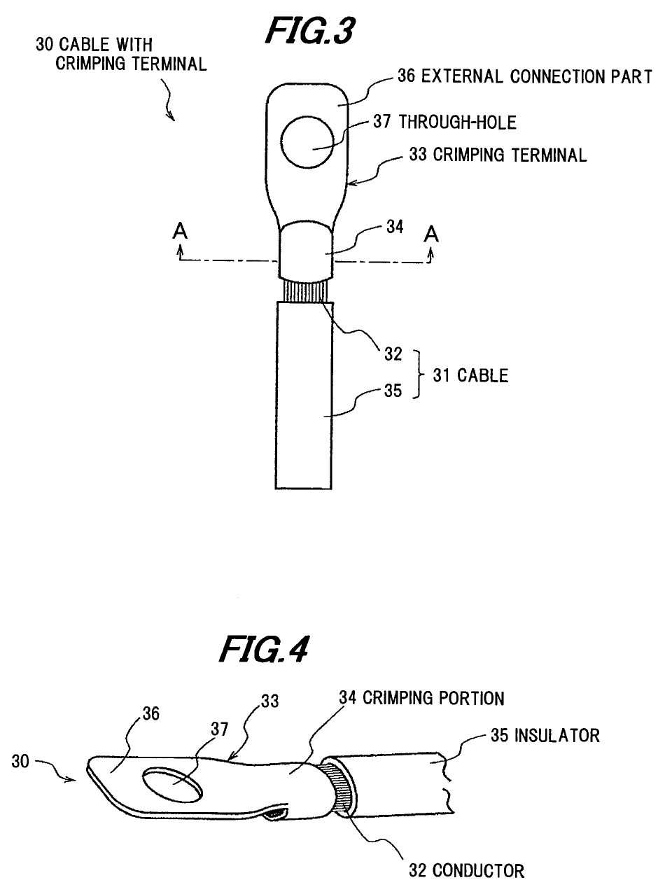

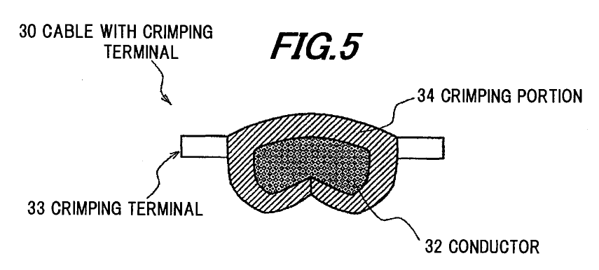

FIG. 1 is a cross-sectional view schematically showing a crimping portion of a cable with a crimping terminal in one embodiment according to the invention. Since, the fundamental structure is the same as that of the conventional cable with crimping terminal 30, it is preferable to refer to FIGS. 3, 4 for the plan view and the perspective view.

As shown in FIG. 1, the cable with the crimping terminal 30 comprises a cable 31 including a conductor 32, a crimping terminal 33 connected to the conductor 32 of the cable 31 at a crimping portion 34 by crimping connection; and a metallic bonding material X via which the conductor 32 of the cable 31 and the crimping terminal 33 are connected at the crimping portion 34.

The cable includes the conductor 32 and an insulator 35 formed of a plastic material. As the conductor 32, for example, twisted wires having a cross-sectional size of almost 8 mm² are preferably used, and as a single wire conductor which constitutes the twisted wires, a soft copper wire coated with tin plating is preferably used. Tin is used for corrosion prevention, and a wire coated with nickel or silver plating is also used depending on the intended use.

The insulator 35 is made of, for example, cross-linked polyethylene. Resin materials such as vinyl chloride and fluorine resin other than polyethylene are also used depending on the intended use. Particularly, with regard to the cable required to have heat resistance, it is necessary to consider the rated temperature of the insulator. Generally, the rated temperature of the insulator is almost 125 degrees C. at the highest in case of the insulator formed of vinyl chloride as a main material, almost 150 degrees C. at the highest in case of cross-linked polyethylene, and almost 250 degrees C. at the highest in case of fluorine resin.

The crimping terminal 33 includes a base portion, and as the material of the base portion, copper is preferably used. Mainly, in terms of the corrosion prevention, the surface of copper is preferably coated with a metal plating such as tin, nickel or silver plating.

The metallic bonding material X includes a sintered body of silver fine particles. The sintered body of silver fine particles is obtained by sintering a bonding material in the form of a liquid or a paste where silver fine particles are dispersed in an organic solvent.

As described above, in case of metallic particles, if the particle size becomes small to the extent of a nanosize, the melting point is decreased so that a fusion bond is caused at a low temperature, and the fusion bond proceeds even at normal temperature. Therefore, if the metallic fine particles are handled, it is convenient to handle the bonding material in the form of a liquid or a paste obtained by the steps of protecting the peripheries of the metallic fine particles with organic materials, and dispersing the protected particles in organic solvents so as to become a liquid or a paste form.

If the bonding material in the form of a liquid or a paste in which the metallic fine particles are dispersed is heated, the organic solvents and the organic materials for protection are vaporized and decomposed. And, it is supposed that by the heating, the metallic fine particles are fusion-bonded, so as to function as a bonding material.

The metallic bonding material X can include copper in addition to silver as constituent elements if the crimping terminal 33 is made of copper. Further, the metallic bonding material X can include copper and tin in addition to silver as constituent elements if the conductor 32 or the crimping terminal 33 has a tin plating layer on the surface.

The metallic bonding material X has a layered structure that is formed so as to be almost sequential and cover the periphery of the conductor 32, and the periphery of the material X is bonded to the crimping terminal 33. Although not shown in the drawings, the metallic bonding material X penetrates into the interior portion of the conductor 32 formed of twisted wires (the spaces between the single wire conductors).

If the metallic bonding material X which includes silver, copper and tin as constituent elements is used, the main component of the material X is silver, but the composition thereof is not homogeneous, and mainly formed of a sintered body of silver fine particles, an alloy of silver and copper and an alloy of silver, copper and tin, and further, a metallurgical bond is respectively formed between the sintered body of silver fine particles and the alloys, and between the respective alloys.

It is preferable to use the silver fine particles of not more than 100 nm in average particle size. This is due to the fact that if the average particle size of the silver fine particles is controlled to be not more than 100 nm, the fusion-bonding (sintering process) of the silver fine particles can be sufficiently progressed at the heat treating temperature and condition that the insulator 35 of the cable 31 is not damaged, and the breaking strength of the crimping portion of the cable with crimping terminal 30 can be enhanced.

To the contrary, if the average particle size is more than 100 nm, the fusion-bonding of the silver fine particles at a low temperature becomes insufficient, so that a problem is caused that the breaking strength of the crimping portion is reduced. In this case, the breaking strength can be enhanced by increasing the heat treating temperature, however, due to this, a problem occurs that the insulator 35 of the cable 31 is damaged.

Here, the average particle size of the silver fine particles is measured by a particle size measurement device using a dynamic light scattering method. “Average particle size” is defined as the particle size which corresponds to the case that the cumulative value is 50% in the cumulative frequency distribution of the particle size. As the particle size measurement device, for example, a measurement device manufactured by Nikkiso Co., Ltd. (model number: UPA-EX150) can be preferably used.

Further, the inventors and the like have found in the investigation of the bonding material relating to the invention that the metallic bonding material X also functions as the excellent bonding material, the material X being obtained by the steps of dispersing silver oxide particles into organic solvents so as to obtain a bonding material in the form of a liquid or a paste and sintering the bonding material. If the metallic bonding material X obtained by the above-mentioned steps is applied to the crimping portion, the breaking strength can be obtained, the strength being the same or more than that of the material X obtained by the steps of dispersing silver particles into organic solvents so as to obtain a bonding material in the form of a liquid or a paste and sintering the bonding at the heat treating temperature and condition that the insulator 35 of the cable 31 is not damaged material.

It is assumed that if the bonding material in the form of a liquid or a paste obtained by dispersing silver oxide particles into organic solvents is heated, reactions of oxidation of organic materials, reduction of silver oxide and generation of silver fine particles proceed in this order, so as to function as a bonding material. Even if the average particle size of silver oxide particles is micron-size it functions as a bonding material.

As silver oxide, for example, silver (I) oxide (Ag₂O) is preferably used. The average particle size is preferably not more than 10 μm, and more preferably not more than 8 μm. If the average particle size is more than 10 μm, a problem may arise that the breaking strength of the crimping portion may be reduced by almost 10%. The reason why the breaking strength is reduced by almost 10% that if the average particle size is more than 10 μm, a large number of voids occur in the metallic bonding material so as to become a factor for the reduction of the breaking strength.

According to the cable with crimping terminal 30 having the above-mentioned structure, since the conductor 32 of the cable 31 and the crimping terminal 33 are connected at the crimping portion via the metallic bonding material X, the breaking strength just after the crimping connection can be increased at the crimping portion of the cable with crimping terminal 30, and even if it is used in a high-temperature environment, the decrease in the breaking strength can be suppressed to an extremely small amount. Further, if the conductor 32 and the crimping terminal 33 which include copper as a main component are used and the surfaces thereof are coated with tin plating, in addition to the above-mentioned advantage corrosion of the conductor 32 and the crimping terminal 33 can be also prevented.

Hereinafter, a method of fabricating the cable with crimping terminal 30 according to the invention will be explained. Here, a case that the metallic bonding material X is applied will be explained, the material X being obtained by the steps of dispersing silver oxide particles into organic solvents so as to obtain a bonding material in the form of a liquid or a paste and sintering the bonding material.

The method of fabricating the cable with crimping terminal 30 according to the invention includes steps of (1) depositing a bonding material in the form of a liquid or a paste including silver oxide on the conductor 32 of the cable 31, (2) connecting the conductor 32 on which the bonding material is deposited and the crimping terminal 33 by crimping connection and (3) heating the crimping portion at the temperature of not more than the melting point of the insulator 35, and fusion-bonding the metallic bonding material X to the conductor and the crimping terminal.

Particularly, in the step (1), after the insulator 35 of the terminal portion of the cable 1 is eliminated, the metallic bonding material X in the form of a liquid or a paste including silver oxide is deposited on the periphery of the conductor 32.

The organic solvent includes, for example, alpha terpineol, ethylene glycol. Other than the above, for example, n-tetradecyl alcohol and glycerin can be also used.

In the step (2), the conductor 32 on which the bonding material in the form of a liquid or a paste is deposited is inserted into the crimping terminal 33, and the crimping connection is carried out by using a die and a press machine. At this time, it is preferable that after preliminarily obtaining knowledge about a relationship between the conductor cross-section ratio of the crimping portion and the applied pressure, and further between the breaking mode and the conductor cross-section ratio, and further a relationship between the breaking strength or the breaking mode and the conductor cross-section ratio, the crimping connection is carried out under appropriate conditions.

In the step (3), the heating process is applied to the crimping portion of the crimping terminal 33. The heating process is carried out, for example, by bringing a metallic heater block with built-in resistance heating elements into contact with the crimping portion. The heating is carried out, for example, under the condition that the temperature of the crimping portion of the crimping terminal 33 becomes 200 degrees C., and for one minute. Due to this, the bonding material in the form of a liquid or a paste which is deposited in the step (1) is sintered and the metallic bonding material X is formed, so that the cable with crimping terminal 30 can be obtained.

According to the method of fabricating the cable with crimping terminal 30 in the embodiment of the invention, the conductor 32 of the cable 31 and the crimping terminal 33 are connected via the metallic bonding material X, so that at the crimping portion of the cable with crimping terminal 30, the breaking strength just after the crimping connection is high and even if the cable is used in a high-temperature environment, the decrease in the breaking strength is suppressed to an extremely small amount.

In the embodiment, the metallic bonding material X in the form of a liquid or a paste is deposited on the periphery of the conductor 32 of the cable 31, however, instead of this, the metallic bonding material X in the form of a liquid or a paste can be also deposited on the crimping portion of the crimping terminal 33, or both of the conductor 32 and the crimping connection of the crimping connection 33.

Further, in the embodiment, the metallic bonding material which is obtained by sintering a bonding material in the form of a liquid or a paste where silver fine particles are dispersed in an organic solvent is used as the metallic bonding material X, however, if the metallic bonding material which is obtained by sintering a bonding material in the form of a liquid or a paste where silver fine particles of not more than 100 nm in average particle size are dispersed in an organic solvent is used as the metallic bonding material X, for example, n-tetradecyl alcohol is preferably used as the organics solvent, and for example, octylamine is also preferably used as the organic material for protecting the periphery of the silver fine particles.

### EXAMPLES

### Examples 1 and 2, Comparative Examples 1 and 2

In order to confirm advantages of the invention, in four processes (Examples 1 and 2, and Comparative Examples 1 and 2), cable with crimping terminals were experimentally fabricated, and the breaking mode and the breaking strength at the respective crimping portions were compared.

In Example 1, the cable with crimping terminal 30 was used, which was fabricated by the method according to the invention (the method where the metallic bonding material which is obtained by sintering a bonding material in the form of a liquid or a paste where silver fine particles are dispersed in an organic solvent was used as the metallic bonding material X ), and in Example 2, the cable with crimping terminal 30 was used, which was subjected to a shelf test at high temperature after being fabricated according to the method of the invention.

In Comparative Example 1, the cable with crimping terminal 30 was used, which was fabricated by the conventional method, and in Comparative Example 2, the cable with crimping terminal 30 was used, which was subjected to a shelf test at high temperature after being fabricated according to the conventional method. The conventional method means a method that after the insulator of the terminal portion of the cable is eliminated, the conductor is inserted into the crimping terminal and then the crimping connection is carried out by using a die and a press machine.

As the insulator, cross-linked polyethylene was used, and as the crimping terminal and the conductor, those which were coated with tin plating were used, and as silver oxide, silver (I) oxide (Ag₂O) having average particle size of 3 μm was used.

The shelf test at high temperature was carried out at a temperature of 180 degrees C. and for 2000 hours. In the respective processes, five kinds of the cables with crimping terminal were experimentally fabricated, the cables respectively having the ratio of the cross-sectional area which changes in the range of 63% to 92%.

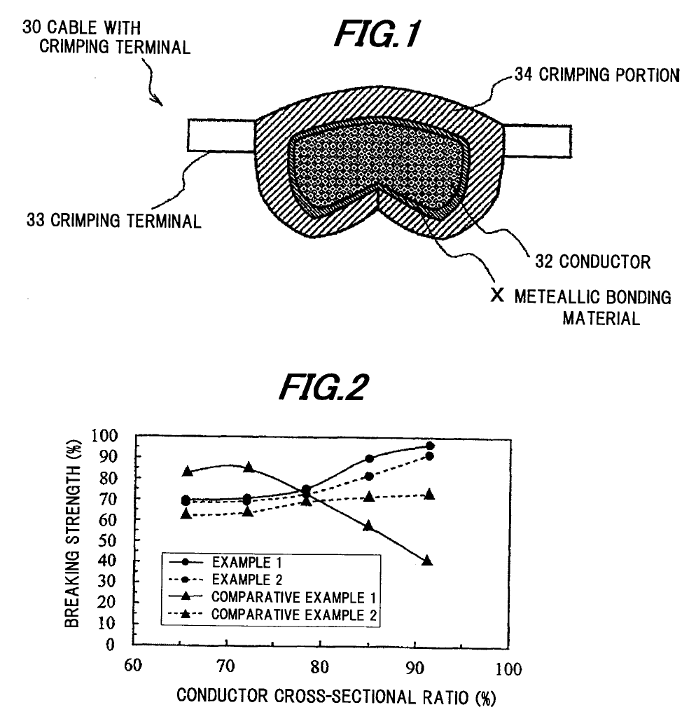

Table 1 shows the breaking mode at the crimping portion of the cable with crimping terminal being experimentally fabricated. Further, FIG. 2 shows a relationship between the breaking strength and the ratio of the cross-sectional area of the cable with crimping terminal being experimentally fabricated. The breaking strength means a relative value in case that breaking load of the unloaded conductor is defined as 100%

TABLE 1

| Ratio of the | | | | |
|---|---|---|---|---|
| cross-sectional | | | Comparative | Comparative |
| area (%) | Example 1 | Example 2 | Example 1 | Example 2 |
| 63 | A (Note 1) | A | A | A |
| 72 | A | A | A | A |
| 79 | A | A | A | A |
| 85 | A | A | B (Note 2) | B |
| 92 | A | A | B | B |

(Note 1): breaking mode A: conductor breaking
(Note 2): breaking mode B: conductor disengagement at crimping portion

First, attention is focused on the conventional cables with crimping terminal experimentally fabricated by Comparative Examples. In case that the ratio of the cross-sectional area was not less than 85%, the breaking mode was conductor disengagement, however, the breaking mode could be the conductor breaking by controlling the ratio to not more than 79%.

In case that the ratio of the cross-sectional area was almost 72%, before the shelf test at high temperature (Comparative Example 1), almost 86% of the breaking strength could be obtained, but after the shelf test at high temperature (Comparative Example 2), the breaking strength was drastically decreased as almost 64%.

Considering the breaking strength after the shelf test at high temperature, it is assumed that an appropriate crimping condition is almost 79% as the ratio of the cross-sectional area, and at this condition the breaking strength before the shelf test at high temperature (Comparative Example 1) was almost 74%, and the breaking strength after the shelf test at high temperature (Comparative Example 2) was almost 70%.

With regard to the conductor, if large plastic deformation is applied to it, the cross-sectional area is decreased, but the strength is increased by work hardening. It is assumed that in case (Comparative Example 1) that the ratio of the cross-sectional area was almost 72%, the reason why the relatively large breaking strength could be obtained is that the work hardening contributed to it. In case of Comparative Example 2, the reason why the breaking strength was drastically decreased is that the conductor was annealed during the shelf test at high temperature and the ratio of the cross-sectional area was decreased up to 72% by the plastic deformation at the crimping connection.

On the other hand, when attention is focused on the cables with crimping terminal according to the invention experimentally fabricated by Examples 1 and 2, the breaking mode was the conductor breaking in a wide range of 63% to 92% of the ratio of the cross-sectional area. It is assumed that an appropriate crimping condition is almost 92% as the ratio of the cross-sectional area, and at this condition the breaking strength before the shelf test at high temperature (Example 1) was almost 97%, and the breaking strength after the shelf test at high temperature (Example 2) was almost 92%, which were extremely high values.

As described above, in the cables with crimping terminal described in Examples 1 and 2, the breaking strength of the crimping portion before the shelf test at high temperature (Example 1) was improved from 74% to 97%, and the breaking strength of the crimping portion after the shelf test at high temperature (Example 2) was improved from 70% to 92% in comparison with the conventional products.

### Examples 3 to 10, and Comparative Examples 3 and 4

Evaluation was carried out with regard to the cables with crimping terminal (Examples 3, 5, 7 and 9) fabricated by using the method of fabricating the cable with crimping terminal of the invention (the method where the metallic bonding material which is obtained by sintering a bonding material in the form of a liquid or a paste where silver fine particles having average particle size of not more than 100 nm are dispersed in an organic solvent was used as the metallic bonding material X, and as the conductor 32 and the crimping terminal 33, the base material made of copper and tin plating coated on the surfaces were used), and the cables with crimping terminal (Examples 4, 6, 8 and 10) which were subjected to the shelf test at high temperature after being fabricated by Examples 3, 5, 7 and 9. Similarly, the cables with crimping terminal (Comparative Examples 3 and 4) were fabricated by using silver fine particles having average particle size of more than 100 nm.

The metallic bonding materials which were obtained by sintering bonding materials in the form of a paste where silver fine particles having average particle size of almost 8 nm (Examples 3 and 4), 20 nm (Examples 5 and 6), 30 nm (Examples 7 and 8), 80 nm (Examples 9 and 10) and 130 nm (Comparative Examples 3 and 4) are dispersed in an organic solvent of n-tetradecyl alcohol were used as the metallic bonding material X. Octylamine was used as the organic material for protecting the periphery of the silver fine particles

In the cables with crimping terminal of Examples 3 to 10, as a result of examining the breaking mode and the breaking strength of the crimping portion, almost the same results as those of Examples 1 and 2 were obtained. That is, at the condition that the ratio of the cross-sectional area of the crimping portion was almost 92%, the breaking strength of the crimping portion before and after the shelf test at high temperature showed such a high value that is more than 90%.

On the other hand, in the cables with crimping terminal of Comparative Examples 3 and 4, the breaking strength was reduced by 20%.

### Example 11 and Comparative Example 5

Next, evaluation was carried out with regard to the cables with crimping terminal (Example 11 and Comparative Example 5) fabricated by using plastic materials other than cross-linked polyethylene such as vinyl chloride and fluorine resin as the insulator 35. In Example 11, the heating process was carried out by an instantaneous heat treatment due to power distribution and in Comparative Example 5, the heat treatment was carried out by using the same method as that of Example 1.

In case of using the cable with vinyl chloride insulator which has relatively low melting temperature, after the heating process of the crimping portion was completed, some amount of deformation to the insulator was found in the vicinity of the crimping terminal (Comparative Example 5). However, there was no influence on the breaking mode and the breaking strength of the crimping portion.

Further, deformation of the vinyl chloride insulator could be prevented by means of carrying out the heating process by an instantaneous heat treatment due to power distribution (Example 11). Particularly, the heating process was carried out by applying power distribution for two seconds in a state that the crimping portion was sandwiched between electrodes for power distribution disposed one above the other.

Power distribution electrical current was adjusted so that the highest achieving temperature of the crimping portion became 220 degrees C. during the power distribution. The breaking mode and the breaking strength of the crimping portion of the cable with crimping terminal (Example 11) fabricated by the above-mentioned method were almost the same as that of Example 1.

From the above facts, it is known that the invention can be also applied to the cable which includes the insulator made of plastic materials having relatively low melting points.

### Example 12

Next, evaluation was carried out with regard to the cable with crimping terminal (Example 12) fabricated by using the crimping terminal 33 and the conductor 32 which were coated with metals plating other than tin plating.

In each case that the crimping terminals 33 were used, which were coated with silver, nickel and copper plating, even if the surface materials (plating materials) of the conductor 32 were changed to silver, nickel, copper and tin, the breaking strength almost equal to that of Example 1 could be obtained.

Similarly, in case that the surface materials of the crimping terminals 33 was tin, even if the surface materials of the conductor 32 were changed to silver, nickel and copper, the breaking strength almost equal to that of Example 1 could be obtained.

From the above facts, it is known that by connecting the conductor of the cable and the crimping terminal via the metallic bonding material X, the breaking strength just after the crimping connection can be increased at the crimping portion of the cable with crimping terminal, and even if it is used in a high-temperature environment, the decrease in the breaking strength can be suppressed to an extremely small amount.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. A cable with a crimping terminal, comprising:
a cable comprising a conductor and an insulator comprising a plastic material; and
the crimping terminal bonded to the conductor of the cable at a crimping portion by crimping connection,
wherein the conductor of the cable is bonded to the crimping terminal by a metallic bonding material at a crimping portion, and
the metallic bonding material includes silver as a main component.

2. The cable with the crimping terminal according to claim 1, wherein the metallic bonding material includes a sintered body of the silver fine particles.

3. The cable with the crimping terminal according to claim 2, wherein the conductor and the crimping terminal comprise a metallic material including copper as a main component, and the metallic bonding material includes an alloy material including silver and copper.

4. The cable with the crimping terminal according to claim 3, wherein the conductor and/or the crimping terminal comprises a tin plating layer on a surface thereof and the metallic bonding material comprises an alloy material containing silver, copper and tin.

5. A method of making a cable with a crimping terminal, comprising:
providing a cable comprising a conductor and an insulator comprising a plastic material, and providing a crimping terminal;
applying a metallic bonding material in a liquid or paste form including silver fine particles of not more than 100 nm in an average particle size to the conductor of the cable and/or the crimping terminal;
bonding the conductor and the crimping terminal at a crimping portion by crimping connection; and
heating the crimping portion at a temperature of not more than a melting point of the insulator so as to fusion-bond the metallic bonding material to the conductor and the crimping terminal.

6. A method of making a cable with a crimping terminal, comprising:
providing a cable comprising a conductor and an insulator comprising a plastic material, and providing a crimping terminal;
applying a metallic bonding material in a liquid or paste form including silver oxide particles to the conductor of the cable and/or the crimping terminal;
bonding the conductor and the crimping terminal at a crimping portion by crimping connection; and
heating the crimping portion at a temperature of not more than a melting point of the insulator so as to fusion-bond the metallic bonding material to the conductor and the crimping terminal.
